(19) United States
(12) Patent Application Publication
(10) Pub. No.: US 2019/0353850 A1
(43) Pub. Date: Nov. 21, 2019

(54) OPTICAL LOOPBACK MEMBER AND OPTICAL LOOPBACK CONNECTOR

(71) Applicant: FUJIKURA LTD., Tokyo (JP)

(72) Inventors: Hirotaka Asada, Chiba (JP); Akihiro Nakama, Chiba (JP); Shigeo Takahashi, Chiba (JP)

(73) Assignee: FUJIKURA LTD., Tokyo (JP)

(21) Appl. No.: 16/484,249

(22) PCT Filed: Feb. 28, 2018
(86) PCT No.: PCT/JP2018/007629

§ 371 Date: Aug. 7, 2019

(30) Foreign Application Priority Data
Mar. 21, 2017 (JP) 2017-054348

(51) Int. Cl. G02B 6/38; G01D 5/28

(52) U.S. Cl. CPC G02B 6/385; G01D 5/28

(57) ABSTRACT

An optical loopback member attaches to a counterpart optical connector to face a plurality of optical fibers of the counterpart optical connector that includes a first input optical fiber, second input optical fiber, first output optical fiber, and second output optical fiber. The optical loopback member includes a first reflector including: a first output light reflection surface that reflects a first output light, outputted in a first direction, from the first output optical fiber; and a first input light reflection surface that reflects light reflected by the first output light reflection surface and directs the reflected light to the first input optical fiber arranged in a second direction with respect to the first output optical fiber. The second direction is perpendicular to the first direction.

### TECHNICAL FIELD

The present invention relates to an optical loopback member and an optical loopback connector, and more particularly to an optical loopback connector attachable to a counterpart optical connector having a plurality of optical fibers.

### BACKGROUND

A loopback test has been known as a method of testing an optical transmission device that forms an optical communication network. The loopback test is to input optical signals outputted from an output of an optical transmission device directly to an input of the optical transmission device to verify whether the optical transmission device works properly.

In recent years, multi-fiber cables including a plurality of optical fibers have frequently been used for transmission of a large amount of data. For a loopback test on an optical transmission device including such a multi-fiber cable, there has been used an optical loopback connector that is attachable to an optical connector provided at an end of a multi-fiber cable (see, e.g., Patent Literature 1).

Such a conventional optical loopback member has a reflection surface configured to reflect and direct light emitted from one of two optical fibers into the other optical fiber. Known multi-fiber connectors include a type in which a plurality of optical fibers are arranged in a single line and a type in which a plurality of optical fibers are arranged in two lines. Conventional optical loopback members assume use for one of the types of multi-fiber connectors and thus cannot perform a loopback test on different types of multi-fiber connectors. Therefore, in order to perform a loopback test on different types of multi-fiber connectors, a separate optical loopback member is required for each type of multi-fiber connectors. Thus, the cost of loopback tests increases.

### Patent Literature

Patent Literature 1: JP 2001-083365 A

### SUMMARY

One or more embodiments of the present invention provide an optical loopback member that can be used without the need for replacement depending on an array of optical fibers in a counterpart optical connector.

One or more embodiments of the present invention provide an optical loopback connector that does not need to replace an optical loopback member depending on an array of optical fibers in a counterpart optical connector.

According to one or more embodiments of the present invention, there is provided an optical loopback member that can be used without the need for replacement depending on an array of optical fibers in a counterpart optical connector. This optical loopback member is attachable to a counterpart optical connector so as to face a plurality of optical fibers of the counterpart optical connector. The optical loopback member has a first reflection portion and a second reflection portion. The first reflection portion has a first output light reflection surface configured to reflect output light outputted in a first direction from an output optical fiber of the plurality of optical fibers and a first input light reflection surface configured to reflect light reflected by the first output light reflection surface and direct the reflected light to a first input optical fiber arranged in a second direction perpendicular to the first direction with respect to the output optical fiber of the plurality of optical fibers. The second reflection portion has a second output light reflection surface configured to reflect the output light from the output optical fiber and a second input light reflection surface configured to reflect light reflected by the second output light reflection surface and direct the reflected light to a second input optical fiber arranged in a third direction perpendicular to the first direction and the second direction with respect to the output optical fiber of the plurality of optical fibers.

In this manner, an optical loopback member according to one or more embodiments of the present invention has a first reflection portion configured to direct output light outputted from the output optical fiber to the first input optical fiber arranged in the second with respect to the output optical fiber and a second reflection portion configured to direct output light outputted from the output optical fiber to the second input optical fiber arranged in the third direction with respect to the output optical fiber. Therefore, an optical loopback member according to one or more embodiments of the present invention allows a loopback test to be performed on counterpart optical connectors having any array pattern of optical fibers, such as a single line, two lines, and three lines, in the second direction. Accordingly, a user does not need to use different optical loopback members depending on an array pattern of optical fibers in a counterpart optical connector. Thus, various types of optical loopback members are not required to be manufactured depending on the array of optical fibers in counterpart optical connectors. Therefore, cost for loopback tests can be reduced.

The optical loopback member may further include a first lens configured to collimate the output light and direct the collimated light to the first output light reflection surface, a second lens configured to focus light directed to the first input optical fiber from the first input light reflection surface to optically couple the focused light to the first input optical fiber, a third lens configured to collimate the output light and direct the collimated light to the second output light reflection surface, and a fourth lens configured to focus light directed to the second input optical fiber from the second input light reflection surface to optically couple the focused light to the second input optical fiber. With such a configuration, light can be collimated and focused even if the counterpart optical connector is not configured to collimate and focus light.

The plurality of optical fibers may be arrayed such that a plurality of optical fiber sets of three optical fibers arranged in the second direction are arranged in the third direction. According to one or more embodiments of the present invention, a loopback test can be completed with one optical loopback member even if the fiber count (the number of optical fibers) in the optical connector is large.

The first reflection portion may be configured such that the first output light reflection surface reflects the output light toward the second direction and that the first input light reflection surface reflects light reflected by the first output light reflection surface toward the first direction. In this case, the first reflection portion may have a plane symmetrical shape that is symmetrical with respect to a plane including a line extending in the third direction and a line extending in the first direction at a central region of the first reflection portion in the second direction. With such a configuration, the first reflection portion can readily be formed.

Each of the first output light reflection surface and the first input light reflection surface may be formed by a single plane extending in parallel to the third direction. With such a configuration, a loopback test using the first reflection portion can be performed with one set of reflection surfaces. Thus, manufacturing cost of the optical loopback member can be reduced without an increase of the number of parts.

The second reflection portion may be configured such that the second output light reflection surface reflects the output light toward the third direction and that the second input light reflection surface reflects light reflected by the second output light reflection surface toward the first direction. In this case, the second reflection portion may have a plane symmetrical shape that is symmetrical with respect to a plane including a line extending in the second direction and a line extending in the first direction at a central region of the second reflection portion in the third direction. With such a configuration, the second reflection portion can readily be formed.

Each of the second output light reflection surface and the second input light reflection surface may be formed by a single plane. With such a configuration, a loopback test using the second reflection portion can be performed with one set of reflection surfaces. Thus, manufacturing cost of the optical loopback member can be reduced without an increase of the number of parts.

According to one or embodiments of the present invention, there is provided an optical loopback connector that does not need to replace an optical loopback member depending on an array of optical fibers in a counterpart optical connector. The optical loopback connector has the aforementioned optical loopback member and a protection member attachable to and detachable from the optical loopback member.

According to one or more embodiments of the present invention, a first reflection portion that can loop light back in the second direction and a second reflection portion that can loop light back in the third direction allow a loopback test to be performed without the need for replacement of optical loopback members depending on an array of optical fibers in a counterpart optical connector.

### BRIEF DESCRIPTION OF DRAWINGS

FIG. 1 is a perspective view showing an optical loopback connector of a first reference example.

FIG. 2 is a cross-sectional view taken along line A-A of FIG. 1.

FIG. 3 is an exploded perspective view of the optical loopback connector illustrated in FIG. 1.

FIG. 4A is a front perspective view showing an optical loopback member of the optical loopback connector illustrated in FIG. 1.

FIG. 4B is a rear perspective view showing the optical loopback member illustrated in FIG. 4A.

FIG. 4C is a cross-sectional view taken along line B-B of FIG. 4A.

FIG. 4D is a cross-sectional view taken along line C-C of FIG. 4A.

FIG. 5 is a diagram schematically showing an optical path in the optical loopback member when the optical loopback connector illustrated in FIG. 1 is attached to a counterpart optical connector.

FIG. 6 is a perspective view showing an optical loopback connector of a second reference example.

FIG. 7 is a cross-sectional view taken along line D-D of FIG. 6

FIG. 8 is a perspective view showing an optical loopback connector according to one or more embodiments of the present invention.

FIG. 9 is a cross-sectional view taken along line E-E of FIG. 8.

FIG. 10 is an exploded perspective view of the optical loopback connector illustrated in FIG. 8.

FIG. 11A is a front perspective view showing an optical loopback member of the optical loopback connector illustrated in FIG. 8.

FIG. 11B is a rear perspective view showing the optical loopback member illustrated in FIG. 11A.

FIG. 11C is a cross-sectional view taken along line F-F of FIG. 11A.

FIG. 11D is a cross-sectional view taken along line G-G of FIG. 11A.

FIG. 12 is a vertical cross-sectional view schematically showing a first pattern of an optical path in the optical loopback member in a state in which one or more embodiments of the optical loopback connector illustrated in FIG. 8 is attached to a counterpart optical connector.

FIG. 13 is a horizontal cross-sectional view schematically showing a second pattern of the optical path in the optical loopback member in a state in which the optical loopback connector illustrated in FIG. 8 is attached to the counterpart optical connector.

FIG. 14 is a vertical cross-sectional view schematically showing another pattern of the optical path in the optical loopback member in a state in which the optical loopback connector illustrated in FIG. 8 is attached to the counterpart optical connector.

FIG. 15 is a schematic diagram showing an optical loopback connector according to one or more embodiments of the present invention.

FIG. 16 is a schematic diagram showing an optical loopback connector according to one or more embodiments of the present invention, along with a counterpart optical connector.

FIG. 17 is a schematic diagram showing an optical loopback connector according to one or more embodiments of the present invention, along with a counterpart optical connector.

### DETAILED DESCRIPTION

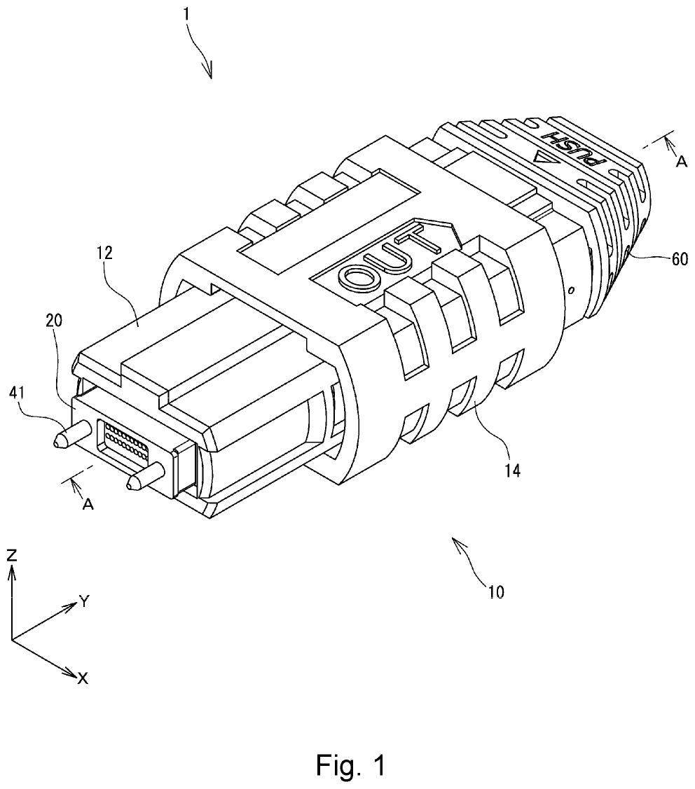

Embodiments of an optical loopback member according to the present invention will be described in detail below with reference to FIGS. 1 to 17. In FIGS. 1 to 17, the same or corresponding components are denoted by the same or corresponding reference numerals and will not be described below repetitively. Furthermore, in FIGS. 1 to 17, the scales or dimensions of components may be exaggerated, or some components may be omitted.

Prior to the explanation of an optical loopback member and an optical loopback connector according to one or more embodiments of the present invention, a first reference example and a second reference example of optical loopback connectors will be described with reference to FIGS. 1 to 7 for better understanding of the present invention.

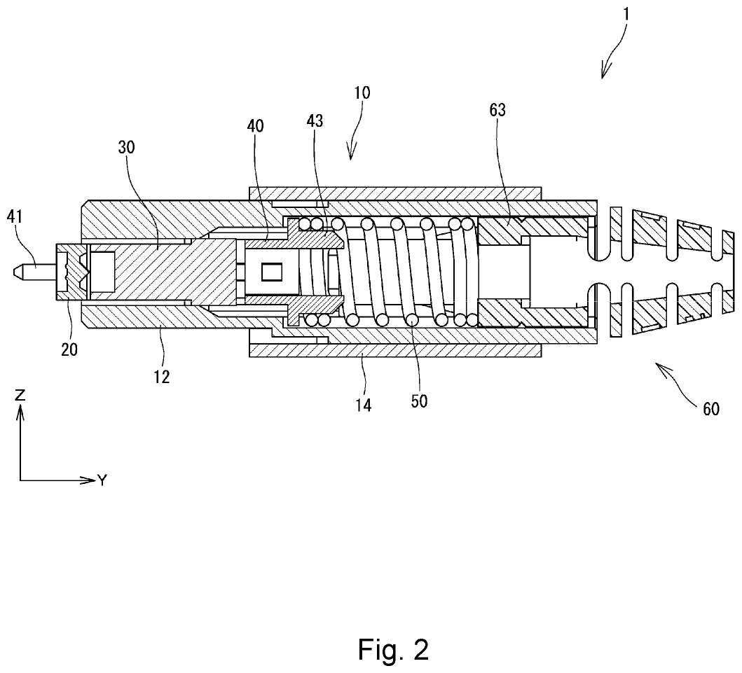

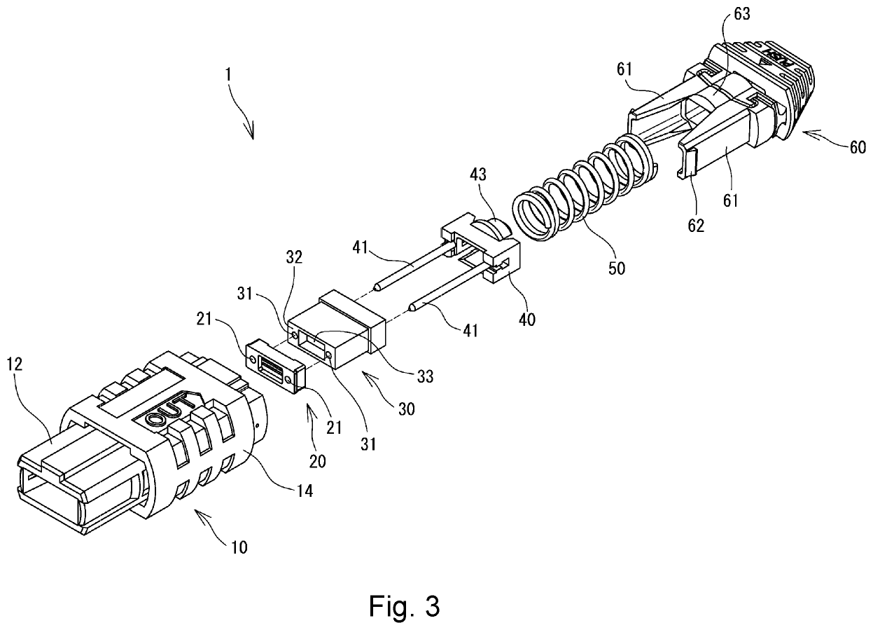

FIG. 1 is a perspective view showing an optical loopback connector 1 of a first reference example, FIG. 2 is a cross-sectional view taken along line A-A of FIG. 1, and FIG. 3 is an exploded perspective view of the optical loopback connector 1. The optical loopback connector 1 of the first reference example is configured as a male type MPO connector. When the optical loopback connector 1 is attached to a female type MPO connector (counterpart optical connector), which is not illustrated, a loopback test can be performed on an optical fiber cable and an optical transmission device connected to the female type MPO connector. In the following description, the left side of FIG. 2 is referred to as “front side” or “front,” and the right side of FIG. 2 is referred to as “rear side” or “rear.”

As shown in FIGS. 1 to 3, the optical loopback connector 1 has a front housing 10, an optical loopback member 20 disposed so as to face a plurality of optical fibers of a counterpart optical connector when the optical loopback connector 1 is attached to the counterpart optical connector, a protection member 30 attached to a rear end of the optical loopback member 20, a pin clamp 40 holding a pair of guide pins 41 and 41, a coil spring 50 for biasing the pin clamp 40 in a frontward direction, and a rear housing 60.

The front housing 10 has a plug frame 12 that can fit in the counterpart optical connector and a coupling 14 used for drawing the optical loopback connector 1 from the counterpart optical connector. The coupling 14 is movable frontward and rearward outside of the plug frame 12. Furthermore, a coil spring (not shown) for biasing the coupling 14 in a frontward direction is housed within the coupling 14.

The rear housing 60 has a pair of guide portions 61 extending frontward, engagement hooks 62 projecting outward at front ends of the guide portions 61, and a spring pusher 63 configured to press the coil spring 50. The pin clamp 40 has a spring holder 43, which corresponds to the spring pusher 63 of the rear housing 60. The coil spring 50 is located in a compressed state between the spring holder 43 of the pin clamp 40 and the spring pusher 63 of the rear housing 60.

The protection member 30, the pin clamp 40, the coil spring 50, and a front portion of the rear housing 60 are housed in the plug frame 12. While a portion of the optical loopback member 20 is housed in the plug frame 12, a front end portion of the optical loopback member 20 projects frontward from the plug frame 12. The engagement hooks 62 of the rear housing 60 are configured to engage with engagement holes (not shown) formed in sidewalls of the plug frame 12. The rear housing 60 is coupled to the front housing 10 by engagement of the engagement hooks 62 of the rear housing 60 with the engagement holes of the plug frame 12.

Through holes 21 and 31 are formed in the optical loopback member 20 and the protection member 30, respectively, to allow the guide pins 41 to be inserted therethrough. When the optical loopback connector 1 has been assembled, the guide pins 41 pass through those through holes 21 and 31 and extend frontward from the optical loopback member 20. The portions of the guide pins 41 that extend frontward are inserted into pin holes of the counterpart optical connector to connect the optical loopback connector 1 to the counterpart optical connector in a state in which the optical loopback connector 1 is positioned with respect to the counterpart optical connector.

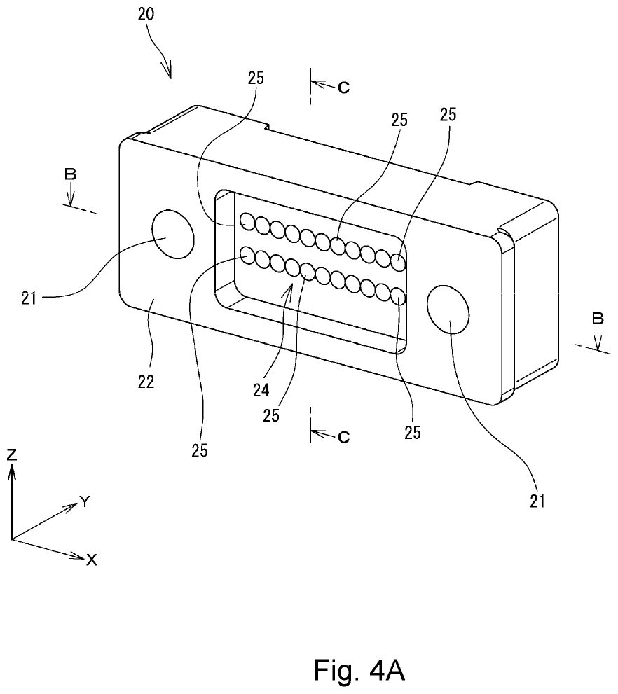

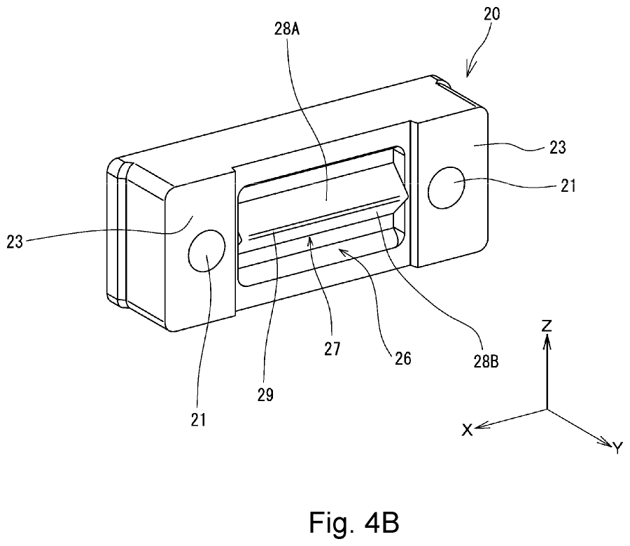

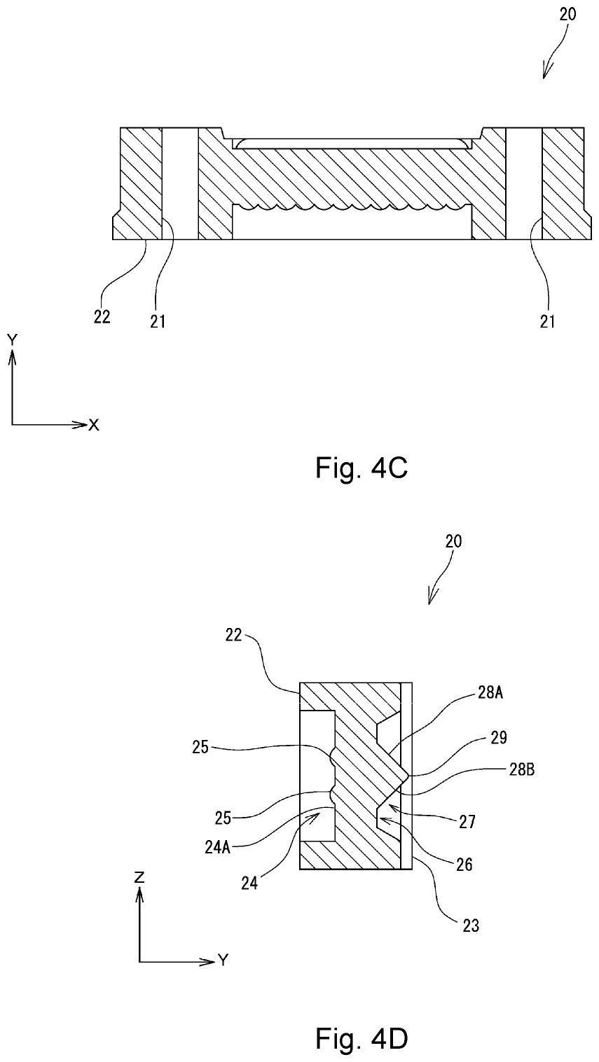

FIG. 4A is a front perspective view showing the optical loopback member 20, FIG. 4B is a rear perspective view, FIG. 4C is a cross-sectional view taken along line B-B of FIG. 4A, and FIG. 4D is a cross-sectional view taken along line C-C of FIG. 4A. As shown in FIGS. 4A to 4D, the optical loopback member 20 is formed by a generally rectangular parallelepiped member having a front end face 22 that can abut the counterpart optical connector and a rear end face 23 that abuts a front end face 32 (see FIG. 3) of the protection member 30. The optical loopback member 20 is formed of a material that allows light that has propagated through a multi-fiber cable connected to the counterpart optical connector to transmit therethrough.

As shown in FIG. 4A, a recessed portion 24 is formed in a central portion of the front end face 22 of the optical loopback member 20. A plurality of lenses 25 are formed at a bottom of the recessed portion 24 so as to face a plurality of optical fibers of the counterpart optical connector. Furthermore, as shown in FIG. 4B, another recessed portion 26 is also formed at a rear side of the optical loopback member 20. A reflection portion 27 in the form of a generally triangular prism is formed at a bottom of the recessed portion 26. The reflection portion 27 has a first reflection surface 28A and a second reflection surface 28B. Each of those reflection surfaces 28A and 28B is an inclined surface extending in the X-direction at an angle of about 45° with respect to the XZ-plane.

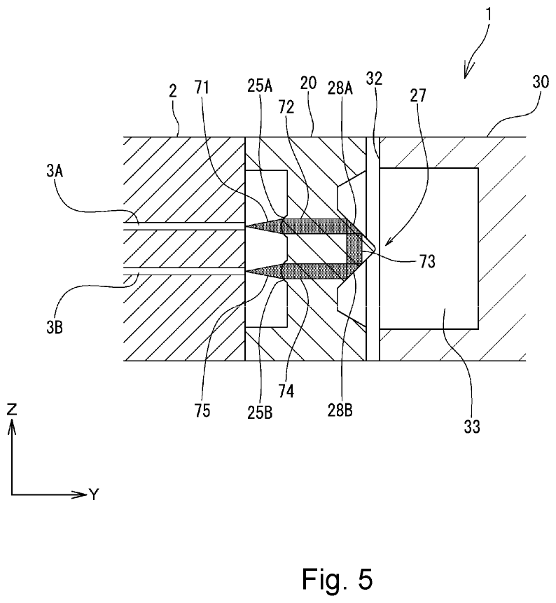

FIG. 5 is a diagram schematically showing an optical path in the optical loopback member 20 when the optical loopback connector 1 is attached to a multi-fiber connector (counterpart optical connector) 2. The optical loopback connector 1 of the first reference example is connected to a multi-fiber connector 2 having 24 optical fibers 3 in use. The multi-fiber connector 2 has 12 pairs of optical fibers arranged in the X-direction, each pair including an optical fiber 3A and an optical fiber 3B arranged in the Z-direction perpendicular to the optical axis (the Y-direction) as shown in FIG. 5. The lenses 25 of the optical loopback member 20 of the first reference example are formed so as to correspond to such an array (two lines in the Z-direction×12 lines in the X-direction) of the optical fibers 3 (see FIG. 4A).

The position of the lenses 25 of the optical loopback member 20 in the Z-direction and the X-direction is determined such that an optical axis of the lens 25 is aligned with an optical axis of a corresponding optical fiber 3 of a multi-fiber connector 2 when the optical loopback connector 1 is attached to the multi-fiber connector 2. Furthermore, the position of the lenses 25 in the Y-direction is determined such that the focal point of the lens 25 is located at an end face of a corresponding optical fiber 3 of the multi-fiber connector 2.

With such a configuration, for example, as shown in FIG. 5, when light 71 for a loopback test is outputted from an optical fiber 3A, the light 71 is introduced into an interior of the optical loopback member 20. The light 71 is collimated by the lens 25A when it is introduced into the optical loopback member 20. The collimated light 72 is reflected by the first reflection surface 28A of the reflection portion 27 to change its direction at 90° and thus directed to the second reflection surface 28B. The light 73 reflected from the first reflection surface 28A is reflected by the second reflection surface 28B to change its direction at 90° so as to form light 74, which is directed to the lens 25B. When the light 74 is emitted from the lens 25B to an optical fiber 3B of the multi-fiber connector 2, it is focused at an end face of the optical fiber 3B by the lens 25B and optically coupled to the optical fiber 3B. Thus, the light 71 outputted from the optical fiber 3A of the multi-fiber connector 2 is looped back to the optical fiber 3B.

As shown in FIGS. 3 and 5, a recessed portion 33 is formed in the front end face 32 of the protection member 30. When the protection member 30 is attached to a rear side of the optical loopback member 20, the reflection portion 27 of the optical loopback member 20 is received within the recessed portion 33 of the protection member 30. Thus, in actual use of the optical loopback connector 1, the reflection portion 27 of the optical loopback member 20 is covered with and protected by the protection member 30. Therefore, the optical characteristics of the reflection surfaces 28A and 28B are prevented from being deteriorated by attachment of foreign matter to the reflection surfaces 28A and 28B of the reflection portion 27.

Meanwhile, the protection member 30 is attachable to and detachable from the optical loopback member 20 via the guide pins 41 and 41. Therefore, when observation of the reflection portion 27 and the reflection surfaces 28A and 28B of the optical loopback member 20 is needed to inspect the optical characteristics of the optical loopback member 20, the reflection portion 27 and the reflection surfaces 28A and 28B can readily be observed by detaching the protection member 30 from the optical loopback member 20. In other words, when the protection member 30 is removed from the optical loopback member 20, the reflection portion 27 of the optical loopback member 20 is exposed externally. For example, an angle between the reflection surface 28A and the second reflection surface 28B or the parallelism of a ridgeline 29 (see FIGS. 4B and 4D) between those reflection surfaces 28A and 28B and a surface 24A (see FIG. 4D) on which the lenses 25 are formed can be measured to examine the precision of the formation of the optical loopback member 20. Accordingly, one can readily determine whether or not the optical loopback member 20 is a conforming product, which has desired optical characteristics. Thus, the optical loopback connector 1 can maintain satisfactory optical characteristics.

As the protection member 30, which protects the reflection portion 27 of the optical loopback member 20, is detachable from the optical loopback member 20, the optical loopback member 20 can be made smaller in size. Therefore, the optical loopback member 20 can be formed with high precision.

In the first reference example, each of the first reflection surface 28A and the second reflection surface 28B extends in parallel to the X-direction (second array direction), in which the fiber pairs of counterpart optical fibers are arranged. Therefore, loopback tests can be performed on a plurality of pairs of optical fibers with one pair of reflection surfaces 28A and 28B. Thus, manufacturing cost of the optical loopback connector 1 can be reduced without an increase of the number of parts.

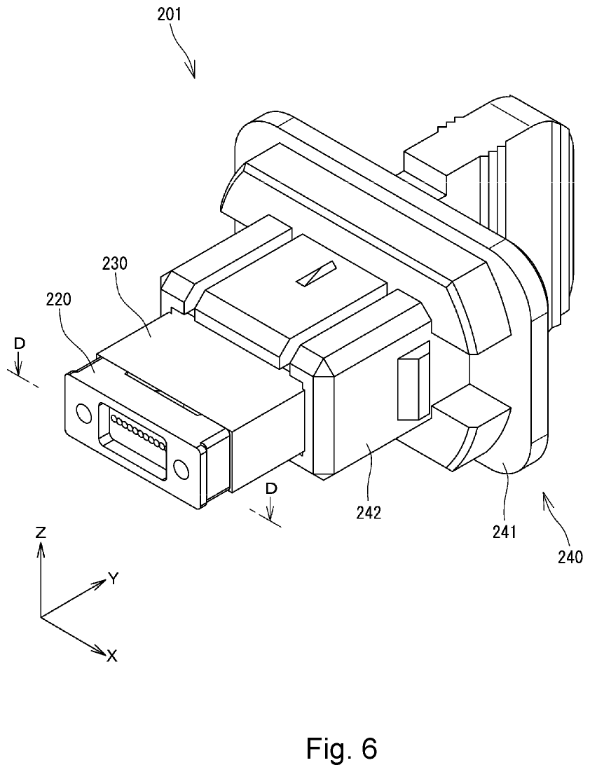

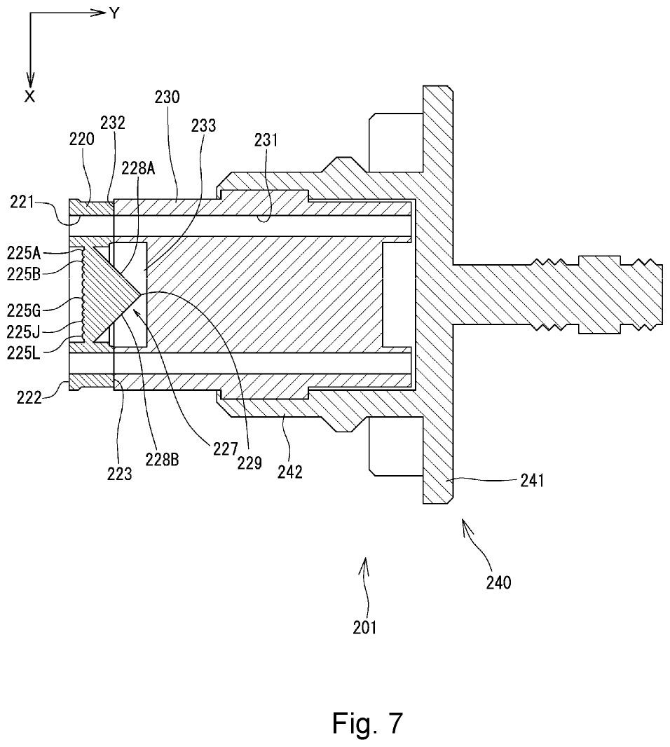

FIG. 6 is a perspective view showing an optical loopback connector 201 of a second reference example, and FIG. 7 is a cross-sectional view taken along line D-D of FIG. 6. As shown in FIGS. 6 and 7, the optical loopback connector 201 of the second reference example has an optical loopback member 220 arranged so as to face a plurality of optical fibers of a counterpart optical connector when the optical loopback connector 201 is attached to the counterpart optical connector, a protection member 230 attached to a rear end of the optical loopback member 220, and a connector cap 240 for holding the protection member 230. The connector cap 240 has a base portion 241 and an enclosure portion 242 in the form of a box that extends from the base portion 241 and surrounds the protection member 230.

As shown in FIG. 7, through holes 221 and 231 through which the aforementioned guide pins 41 are inserted are formed in the optical loopback member 220 and the protection member 230, respectively. Therefore, when the optical loopback connector 201 is used as a male type connector, the guide pins 41 are inserted through those through holes 221 and 231 so that the guide pins 41 extend frontward from the optical loopback member 220.

The optical loopback member 220 is formed by a generally rectangular parallelepiped member having a front end face 222 that can abut the counterpart optical connector and a rear end face 223 that abuts a front end face 232 of the protection member 230. The optical loopback member 220 is formed of a material that allows light that has propagated through a multi-fiber cable connected to the counterpart optical connector to transmit therethrough. Furthermore, a recessed portion is formed in a central portion of the front end face 222 of the optical loopback member 220, and a plurality of lenses 225A-225L are formed at a bottom of the recessed portion so as to face a plurality of optical fibers of the counterpart optical connector. Another recessed portion is also formed at a rear side of the optical loopback member 220, and a reflection portion 227 in the form of a generally triangular prism is formed at a bottom of the recessed portion. The reflection portion 227 has a first reflection surface 228A and a second reflection surface 228B. Each of those reflection surfaces 228A and 228B is an inclined surface extending in the Z-direction at an angle of about 45° with respect to the XZ-plane.

The optical loopback connector 201 of the second reference example is connected to a multi-fiber connector (counterpart optical fiber) having 12 optical fibers arranged in a single line along the X-direction in use. The lenses 225A-225L of the optical loopback member 220 of the second reference example are provided so as to correspond to such an array of optical fibers. Specifically, the position of the lenses 225A-225L of the optical loopback member 220 in the Z-direction and the X-direction is determined such that an optical axis of the lens 225A-225L is aligned with an optical axis of a corresponding optical fiber of a counterpart optical connector when the optical loopback connector 201 is attached to the counterpart optical connector. The position of the lenses 225A-225L in the Y-direction is determined such that the focal point of the lens 225A-225L is located at an end face of a corresponding optical fiber of the counterpart optical connector.

With such a configuration, for example, when light for a loopback test is outputted from an optical fiber located at the outermost position in the X-direction among the optical fibers of the counterpart optical connector, the light is collimated by the lens 225A (see FIG. 7) and introduced into the optical loopback member 220. Then the light is reflected by the first reflection surface 228A of the reflection portion 227 to change its direction at 90°, thus directed to the second reflection surface 228B, reflected by the second reflection surface 228B to change its direction at 90°, and thus directed to the lens 225L. Light emitted from the lens 225L is focused at an end face of the optical fiber of the counterpart optical connector by the lens 225L and optically coupled to that optical fiber. Similarly, light is looped back between the lens 225B and the lens 225K, between the lens 225C and the lens 225J, between the lens 225D and the lens 225I, between the lens 225E and the lens 225H, between the lens 225F and the lens 225G, respectively.

In the second reference example, as shown in FIG. 7, a recessed portion 233 is formed in the front end face 232 of the protection member 230. When the protection member 230 is attached to a rear side of the optical loopback member 220, the reflection portion 227 of the optical loopback member 220 is received within the recessed portion 233 of the protection member 230. Thus, in actual use of the optical loopback connector 201, the reflection portion 227 of the optical loopback member 220 is covered with and protected by the protection member 230. Therefore, the optical characteristics of the reflection surfaces 228A and 228B of the reflection portion 227 are prevented from being deteriorated by attachment of foreign matter to the reflection surfaces 228A and 228B.

Furthermore, the protection member 230 is attachable to and detachable from the optical loopback member 220. Therefore, when observation of the reflection portion 227 and the reflection surfaces 228A and 228B of the optical loopback member 220 is needed to inspect the optical characteristics of the optical loopback member 220, the reflection portion 227 and the reflection surfaces 228A and 228B can readily be observed by detaching the protection member 230 from the optical loopback member 220. In other words, when the protection member 230 is removed from the optical loopback member 220, the reflection portion 227 of the optical loopback member 220 is exposed externally. For example, an angle between the reflection surface 228A and the second reflection surface 228B or the parallelism of a ridgeline 229 (see FIG. 7) between those reflection surfaces 228A and 228B and a surface on which the lenses 225A-225L are formed can be measured to examine the precision of the formation of the optical loopback member 220. Accordingly, one can readily determine whether or not the optical loopback member 220 is a conforming product, which has desired optical characteristics. Thus, the optical loopback connector 1 can maintain satisfactory optical characteristics.

Furthermore, in the second reference example, each pair of optical fibers for which light is looped back (for example, an optical fiber corresponding to the lens 225A and an optical fiber corresponding to the lens 225L, an optical fiber corresponding to the lens 225B and an optical fiber corresponding to the lens 225K, and so forth) are arranged in the same direction (X-direction). Therefore, loopback tests can be performed on a plurality of pairs of optical fibers with one pair of reflection surfaces 228A and 228B. Thus, manufacturing cost of the optical loopback connector 201 can be reduced without an increase of the number of parts.

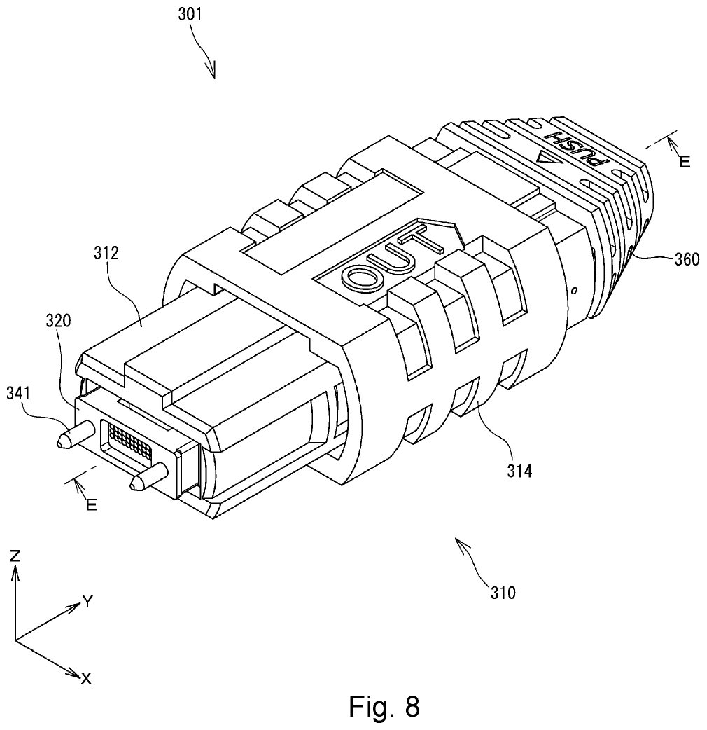

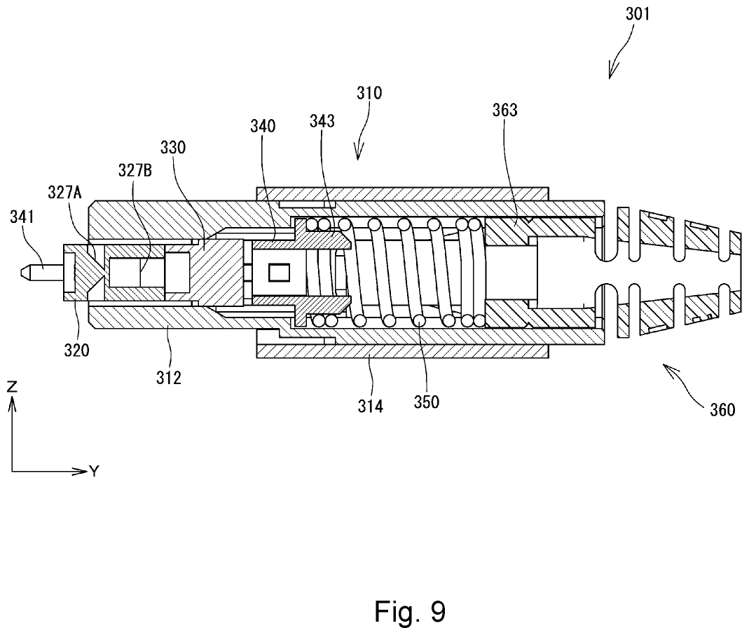

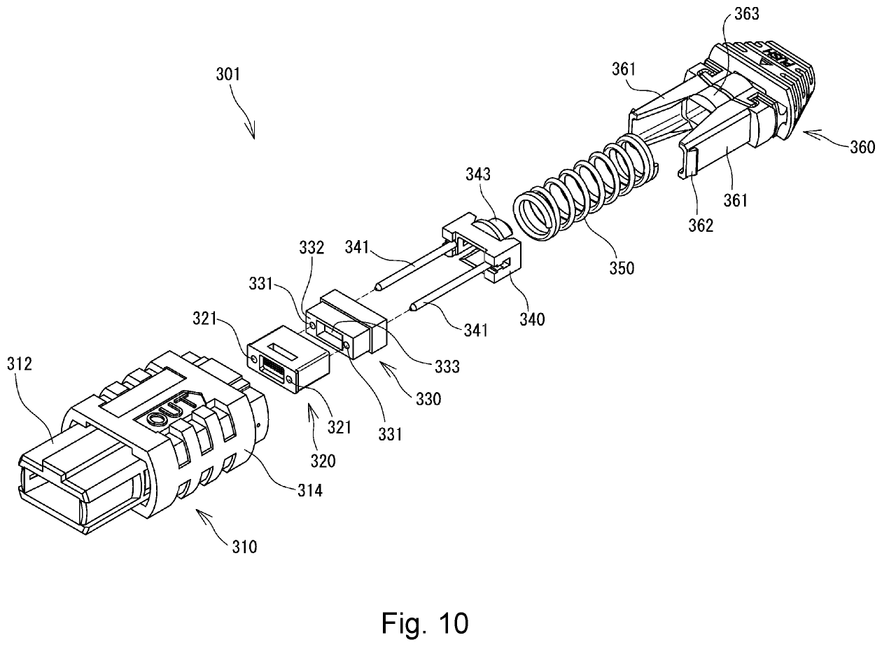

Now an optical loopback connector and an optical loopback member according to one or more embodiments of the present invention will be described in detail. FIG. 8 is a perspective view showing an optical loopback connector 301 according to one or more embodiments of the present invention, FIG. 9 is a cross-sectional view taken along line E-E of FIG. 8, and FIG. 10 is an exploded perspective view of the optical loopback connector 301. The optical loopback connector 301 of one or more embodiments is configured as a male type MPO connector. When the optical loopback connector 301 is attached to a female type MPO connector (counterpart optical connector), which is not illustrated, a loopback test can be performed on an optical fiber cable and an optical transmission device connected to the female type MPO connector. In the following description, the left side of FIG. 9 is referred to as “front side” or “front,” and the right side of FIG. 9 is referred to as “rear side” or “rear.”

As shown in FIGS. 8 to 10, the optical loopback connector 301 has a front housing 310, an optical loopback member 320 disposed so as to face a plurality of optical fibers of a counterpart optical connector when the optical loopback connector 301 is attached to the counterpart optical connector, a protection member 330 attached to a rear end of the optical loopback member 320, a pin clamp 340 holding a pair of guide pins 341 and 341, a coil spring 350 for biasing the pin clamp 340 in a frontward direction, and a rear housing 360.

The front housing 310 has a plug frame 312 that can fit in the counterpart optical connector and a coupling 314 used for drawing the optical loopback connector 301 from the counterpart optical connector. The coupling 314 is movable frontward and rearward outside of the plug frame 312. Furthermore, a coil spring (not shown) for biasing the coupling 314 in a frontward direction is housed within the coupling 314.

The rear housing 360 has a pair of guide portions 361 extending frontward, engagement hooks 362 projecting outward at front ends of the guide portions 361, and a spring pusher 363 configured to press the coil spring 350. The pin clamp 340 has a spring holder 343, which corresponds to the spring pusher 363 of the rear housing 360. The coil spring 350 is located in a compressed state between the spring holder 343 of the pin clamp 340 and the spring pusher 363 of the rear housing 360.

The protection member 330, the pin clamp 340, the coil spring 350, and a front portion of the rear housing 360 are housed in the plug frame 312. While a portion of the optical loopback member 320 is housed in the plug frame 312, a front end portion of the optical loopback member 320 projects frontward from the plug frame 312. The engagement hooks 362 of the rear housing 360 are configured to engage with engagement holes (not shown) formed in sidewalls of the plug frame 312. The rear housing 360 is coupled to the front housing 310 by engagement of the engagement hooks 362 of the rear housing 360 with the engagement holes of the plug frame 312.

As shown in FIG. 10, through holes 321 and 331 are formed in the optical loopback member 320 and the protection member 330, respectively, to allow the guide pins 341 to be inserted therethrough. When the optical loopback connector 301 has been assembled, the guide pins 341 pass through those through holes 321 and 331 and extend frontward from the optical loopback member 320 (see FIG. 8). The portions of the guide pins 341 that extend frontward are inserted into pin holes of the counterpart optical connector to connect the optical loopback connector 301 to the counterpart optical connector in a state in which the optical loopback connector 301 is positioned with respect to the counterpart optical connector.

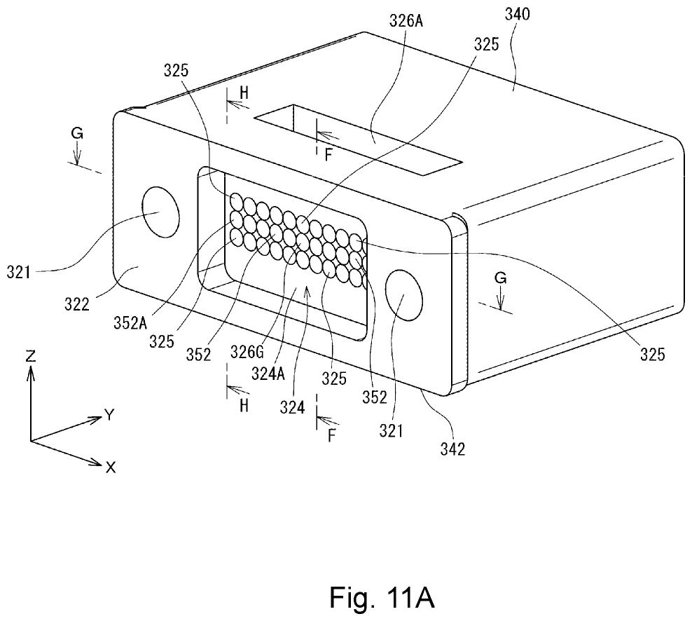

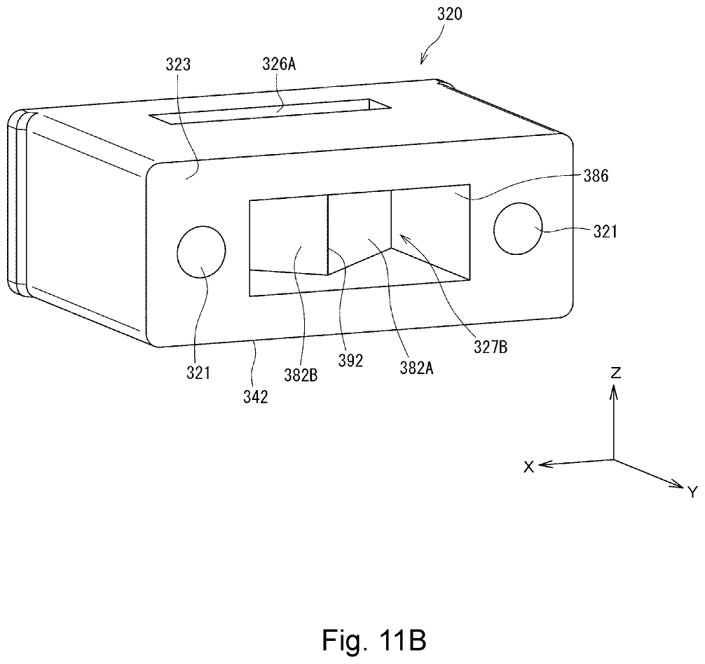

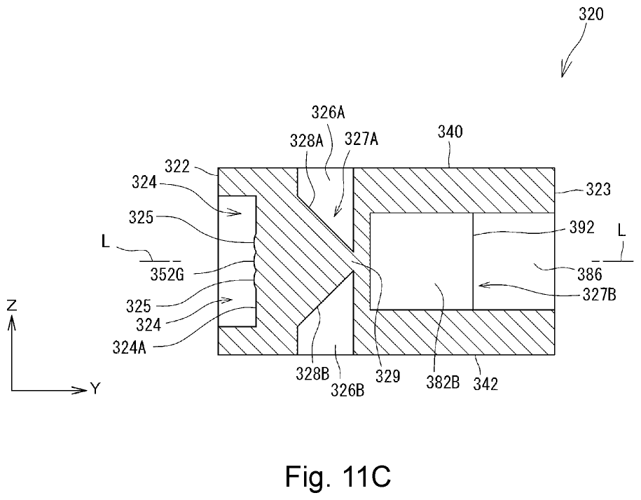

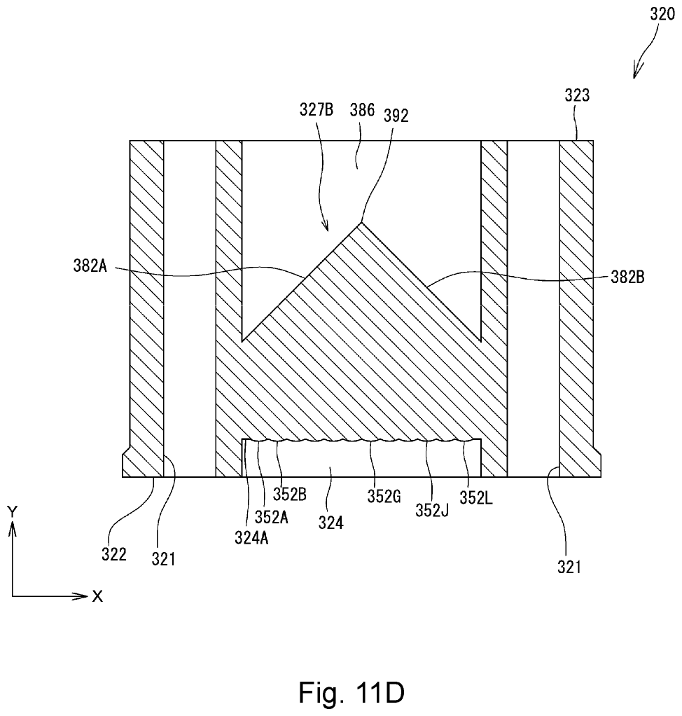

FIG. 11A is a front perspective view showing the optical loopback member 320 according to one or more embodiments of the present invention, FIG. 11B is a rear perspective view, FIG. 11C is a cross-sectional view taken along line F-F of FIG. 11A, and FIG. 11D is a cross-sectional view taken along line G-G of FIG. 11A. As shown in FIGS. 11A to 11D, the optical loopback member 320 is formed by a generally rectangular parallelepiped member having a front end face 322 that can abut the counterpart optical connector and a rear end face 323 that abuts a front end face 332 (see FIG. 10) of the protection member 330. The optical loopback member 320 is formed of a material that allows light that has propagated through a multi-fiber cable connected to the counterpart optical connector to transmit therethrough.

As shown in FIG. 11A, a recessed portion 324 is formed in a central portion of the front end face 322 of the optical loopback member 320. A plurality of lenses 325 and 352 are formed at a bottom surface 324A of the recessed portion 324 so as to face a plurality of optical fibers of the counterpart optical connector.

Furthermore, as shown in FIGS. 11B and 11C, another recessed portion 326A is also formed in an upper surface 340 (surface on the +Z side) of the optical loopback member 320 at a location slightly deviated in the −Y-direction from a central portion of the upper surface 340. The recessed portion 326A has a surface on the −Z side, which is a boundary surface between a material of the optical loopback member 320 and air and thus serves as a reflection surface 328A to reflect light that has transmitted within the optical loopback member 320. This reflection surface 328A is an inclined surface extending in the X-direction at an angle of about 45° with respect to the XZ-plane.

Similarly, as shown in FIG. 11C, still another recessed portion 326B is formed in a lower surface 341 (surface on the −Z side) of the optical loopback member 320 at a location slightly deviated in the −Y-direction from a central portion of the lower surface 342. The recessed portion 326B has a surface on the +Z side, which is a boundary surface between the material of the optical loopback member 320 and air and thus serves as a reflection surface 328B to reflect light that has transmitted within the optical loopback member 320. This reflection surface 328B is an inclined surface extending in the X-direction at an angle of about 45° with respect to the XZ-plane.

In FIG. 11C, those reflection surfaces 328A and 328B are formed so as to have line symmetry with respect to a center line L of the optical loopback member 320 in the Z-direction. The reflection surfaces 328A and 328B form a first reflection portion (first reflector) 327A, which has a generally triangular shape in the YZ-pane, within the optical loopback member 320. The first reflection portion 327A has a tip portion 329 located on the center line L.

As shown in FIGS. 11B to 11D, a recessed portion 386 is formed in a central portion of the rear end face 323 of the optical loopback member 320. The recessed portion 386 has a surface on the −Y side, which is a boundary surface between the material of the optical loopback member 320 and air and thus serves as a second reflection portion (second reflector) 327B to reflect light that has transmitted within the optical loopback member 320. The second reflection portion 327B is in the form of a generally triangular prism and has a first reflection surface 382A expanding toward the −X-direction from a ridgeline 392 and a second reflection surface 382B expanding toward the +X-direction from the ridgeline 392. Each of those reflection surfaces 382 A and 382B is an inclined surface extending in the Z-direction at an angle of about 45° with respect to the XZ-plane.

As shown in FIGS. 9 and 11C, the first reflection portion 327A is located on a front side of the second reflection portion 327B. Specifically, the first reflection portion 327A is located relatively closer to the bottom surface 324A of the recessed portion 324 (the surface on which the lenses 325 and 352 are formed). The second reflection portion 327B is located relatively farther away from the bottom surface 324A of the recessed portion 324.

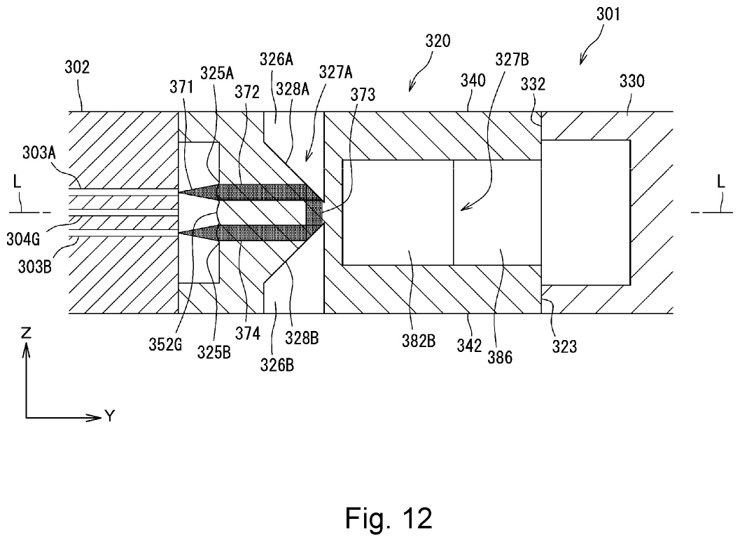

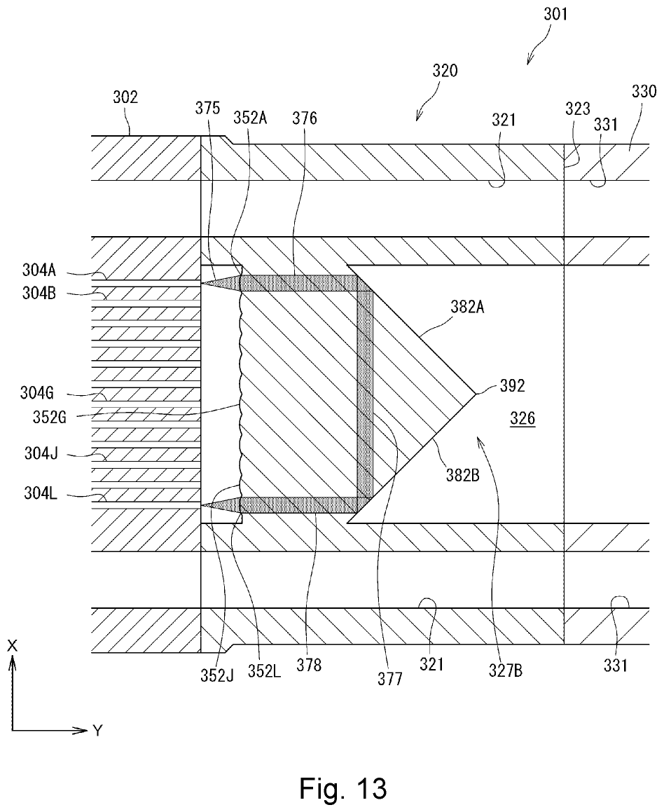

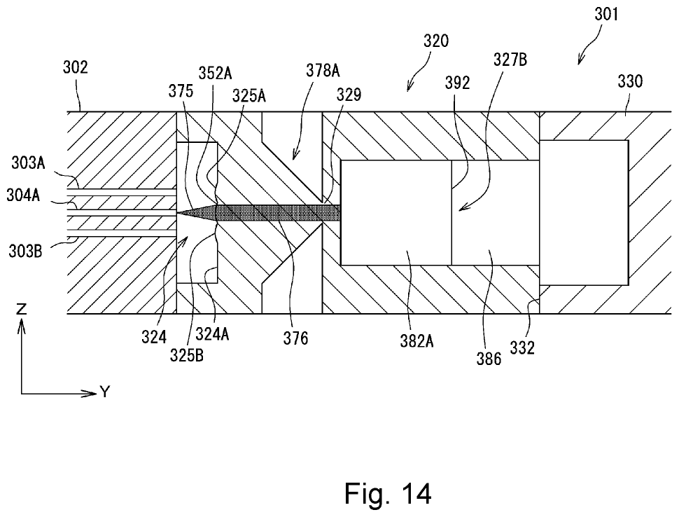

FIG. 12 is a vertical cross-sectional view taken at line F-F of FIG. 11A in the X-direction by cutting an assembly formed when the optical loopback connector 301 is attached to a multi-fiber connector (counterpart optical connector) 302. FIG. 12 schematically illustrates a first pattern of an optical path in the optical loopback member 320. FIG. 13 is a horizontal cross-sectional view taken at line G-G of FIG. 11A in the Z-direction by cutting the aforementioned assembly. FIG. 13 schematically illustrates a second pattern of an optical path in the optical loopback member 320. FIG. 14 is a vertical cross-sectional view taken at line H-H of FIG. 11A in the X-direction by cutting the aforementioned assembly. FIG. 14 schematically illustrates the second pattern of the optical path in the optical loopback member 320.

As shown in FIGS. 12 to 14, the optical loopback connector 301 of one or more embodiments is connected to a multi-fiber connector 302 having 36 optical fibers 303 and 304 in use. The multi-fiber connector 302 has twelve pairs of optical fibers 303A and 303B that are arranged in the Z-direction (second direction), which is perpendicular to the optical axis (Y-direction (first direction)). The twelve pairs are arranged in the X-direction (third direction) (see FIGS. 12 and 14). Twelve optical fibers 304 are also arranged in the X-direction (see FIG. 13). As shown in FIGS. 12 and 14, each of 12 optical fibers 304 is arranged in a central portion between the optical fiber 303A and the optical fiber 303B along the Z-direction (i.e., on the center line L illustrated in FIG. 12). Specifically, the multi-fiber connector 302 has 36 optical fibers including twelve sets of three optical fibers arranged in the Z-direction while the twelve sets are arranged in the X-direction.

As shown in FIGS. 11A and 12, the lenses 325 of the optical loopback member 320 of one or more embodiments are provided so as to correspond to the array of the optical fibers 303 (2 lines in the Z-direction (second direction)×12 lines in the X-direction (third direction)). Specifically, the position of the lenses 325 of the optical loopback member 320 in the Z-direction and the X-direction is determined such that the optical axis of each of the lenses 325 is aligned with the optical axis of the corresponding optical fiber 303 of the multi-fiber connector 302 when the optical loopback connector 301 is attached to the multi-fiber connector 302. The position of the lenses 325 in the Y-direction is determined such that the focal point of each of the lenses 325 is located at an end face of the corresponding optical fiber 303 of the multi-fiber connector 302.

With such a configuration, for example, when light 371 for a loopback test (first output light) is outputted from the optical fiber 303A (first output optical fiber) as shown in FIG. 12, the light 371 is introduced into the optical loopback member 320 and collimated by the lens 325A (first lens) at that time. The collimated light 372 is reflected by the first reflection surface 328A (first output light reflection surface) of the first reflection portion 327A to change its direction at 90° and thus directed to the second reflection surface 328B. That is, the collimated light 372 is reflected into the −Z-direction at the first reflection surface 328A and directed to the second reflection surface 328B.

The light 373 reflected at the first reflection surface 328A is reflected at the second reflection surface 328B to change its direction at 90° and form light 374 directed to the lens 325B. In other words, the light 373 is reflected to the −Y-direction at the second reflection surface 328B (first input light reflection surface) to form light 374 directed to the lens 325B. The light 374 (input light) is emitted from the lens 325B toward the optical fiber 303B of the multi-fiber connector 302. At that time, the light 374 is focused at an end face of the optical fiber 303B by the lens 325B (second lens) and optically coupled to the optical fiber 303B. Thus, the light 371 outputted from the optical fiber 303A of the multi-fiber connector 302 is looped back in the Z-direction and inputted to the optical fiber 303B (first input optical fiber). Hereinafter, such a loopback in the Z-direction may be referred to as a first loopback.

As shown in FIGS. 11A and 13, the lenses 352 (lenses 352A-352L) of one or more embodiments are provided so as to correspond to the array of the optical fibers 304 (twelve lines in the X-direction). Specifically, the position of the lenses 352A-352L of the optical loopback member 320 in the Z-direction and the X-direction is determined such that the optical axis of each of the lenses 352A-352L is aligned with the optical axis of the corresponding optical fiber 304A-304L of the counterpart optical connector when the optical loopback connector 301 is attached to the multi-fiber connector 302. Additionally, each of the lenses 352A-352L is provided so as to face a corresponding optical fiber 304A-304L (see FIG. 13) and arranged in a central portion between the lenses 325A and 325B along the Z-direction (e.g., on the center line L illustrated in FIG. 12). Furthermore, as shown in FIGS. 13 and 14, the position of the lenses 352A-352L in the Y-direction is determined such that the focal point of each of the lenses 352A-352L is located at an end face of the corresponding optical fiber 304A-304L of the counterpart optical connector.

With such a configuration, for example, when light 375 for a loopback test (second output light) is outputted from the optical fiber 304A (second output optical fiber) located at the outermost position in the +X-direction among the optical fibers 304A-304L of the multi-fiber connector 302 as shown in FIGS. 13 and 14, the light 375 propagates along the Y-direction so as to be introduced into the optical loopback member 320. The light 375 is collimated by the lens 352A (third lens) located at the outermost position in the +X-direction when it is introduced into the optical loopback member 320.

The collimated light 376 propagates along the Y-direction as shown in FIG. 14 and passes through the first reflection portion 327A. The collimated light 376 passes through the tip portion 329 of the first reflection portion 327A, which is located on this optical path, and further propagates rearward (toward the second reflection portion 327B). As shown in FIG. 13, the light 376 that has propagated to the second reflection portion 327B is reflected at the first reflection surface 382A (second output light reflection surface) of the second reflection portion 327B to change its direction at 90° and thus directed to the second reflection surface 382B. That is, the light 376 is reflected to the −X-direction at the first reflection surface 382A and directed to the second reflection surface 382B.

As shown in FIG. 13, the light 377 that has been reflected at the first reflection surface 382A is reflected at the second reflection surface 382B to change its direction at 90° and form light 378, which is directed toward the lens 352L located at the outermost position in the −X-direction. That is, the light 377 is reflected to the −Y-direction at the second reflection surface 382B (second input light reflection surface) to form light 384 (input light) directed to the lens 352L. The light 384 propagates through the optical loopback member 320, passes through the tip portion 329 of the first reflection portion 327A, and further propagates frontward (toward the lens 352L) (see FIG. 14).

Finally, as shown in FIG. 13, the light 378 (input light) is emitted to the optical fiber 304L (second input optical fiber) located at the outermost position in the −X-direction. At that time, the light 378 is focused at an end face of the optical fiber 304L by the lens 352L (fourth lens) and optically coupled to the optical fiber 304L. Thus, the light 375 outputted from the optical fiber 303A located at the outermost position in the +X-direction is looped back in the X-direction and inputted to the optical fiber 304L located at the outermost position in the −X-direction. Hereinafter, such a loopback in the X-direction may be referred to as a second loopback. Similarly, a second loopback is performed between the lens 225B and the lens 225K, between the lens 225C and the lens 225J, between the lens 225D and the lens 225I, between the lens 225E and the lens 225H, and between the lens 225F and the lens 225G, respectively.

As described above, according to one or more embodiments, when an optical loopback test is performed on a multi-fiber connector having a plurality of pairs of optical fibers 303A and 303B (e.g., a 24-fiber connector or a 32-fiber connector), light can be looped back in the Z-direction by the first reflection portion 327A. Additionally, when an optical loopback test is performed on a multi-fiber connector having a plurality of optical fibers 304 (e.g., a 12-fiber connector or a 16-fiber connector), light can be looped back in the X-direction by the second reflection portion 327B. Therefore, optical loopback tests can be performed with one optical loopback member, irrespective of the number of lines (a single line, two lines, or three lines) in an array of optical fibers of a counterpart optical connector.

Furthermore, optical loopback tests can be performed with one optical loopback member on counterpart optical connectors having various types of array arrangements. Therefore, various types of optical loopback members are not required to be produced depending on various types of array arrangements of counterpart optical fibers. In other words, when optical loopback members are manufactured, any change or adjustment of molds is not required by change in the fiber count (the number of optical fibers) in counterpart optical connectors.

In one or more embodiments, each of the first reflection surface 328A and the second reflection surface 328B of the first reflection portion 327A extends in parallel to the X-direction, in which the fiber pairs (each including the optical fibers 303A and 303B) of the counterpart optical fiber are arranged. Therefore, a loopback test with a first loopback can be performed with one set of reflection surfaces 328A and 328B. Thus, manufacturing cost of the optical loopback member can be reduced without an increase of the number of parts.

Furthermore, according to one or more embodiments, respective sets of optical fibers for which the aforementioned second loopback is to be performed (e.g., the optical fiber corresponding to the lens 352A and the optical fiber 304L corresponding to the lens 352L, the optical fiber corresponding to the lens 352B and the optical fiber corresponding to the lens 352K, and the like) are arranged in the same direction (X-direction). Accordingly, a loopback test with a second loopback can be performed with one set of the reflection surfaces 382A and 382B of the second reflection portion 327B. Thus, manufacturing cost of the optical loopback member can further be reduced without an increase of the number of parts.

As shown in FIGS. 10 and 14, the optical loopback connector 301 includes a protection member 330 that is attachable to and detachable from the optical loopback member 320 via the guide pins 341 and 341. Therefore, in actual use of the optical loopback connector 301, the second reflection portion 327B of the optical loopback member 320 is covered with and protected by the protection member 330. Accordingly, the optical characteristics of the reflection surfaces 328A and 328B of the second reflection portion 327B are prevented from being deteriorated by attachment of foreign matter to the reflection surfaces 328A and 328B.

Meanwhile, when observation of the second reflection portion 327B of the optical loopback member 320 is needed to inspect the optical characteristics of the optical loopback member 320, the second reflection portion 327B can readily be observed by detaching the protection member 330 from the optical loopback member 320. In other words, when the protection member 330 is removed from the optical loopback member 320, the second reflection portion 327B of the optical loopback member 320 is exposed externally. For example, an angle between the first reflection surface 382A and the second reflection surface 382B or the parallelism of a ridgeline 392 (see FIGS. 11C and 11D) between those reflection surfaces 382A and 382B and a surface 324A (see FIG. 11D) on which the lenses 352 are formed can be measured to examine the precision of the formation of the second reflection portion 327B.

Furthermore, as the protection member 330, which protects the optical loopback member 320, is attachable to and detachable from the optical loopback member 320, the optical loopback member 320 can be made smaller in size. Therefore, the optical loopback member 320 can be formed with high precision.

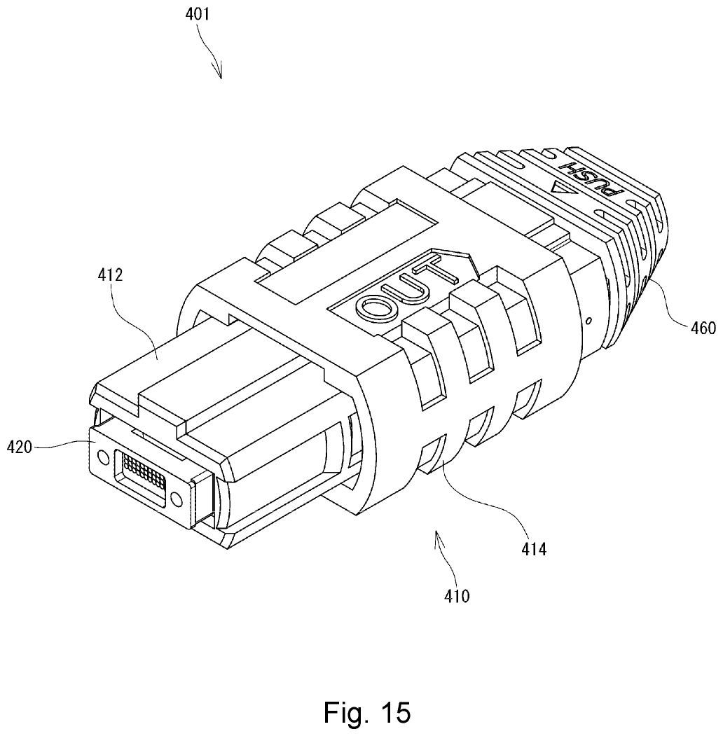

In the aforementioned embodiments, the optical loopback connector is formed as a male-type MPO connector and attached to a female-type MPO connector as the counterpart optical connector. However, for example, as shown in FIG. 15, the optical loopback connector may be formed as a female-type MPO connector 401 and attached to a male-type MPO connector. Furthermore, the optical loopback connector according to one or more embodiments is not limited to an MPO connector and can be attached to any counterpart optical connector as long as it has a plurality of optical fibers.

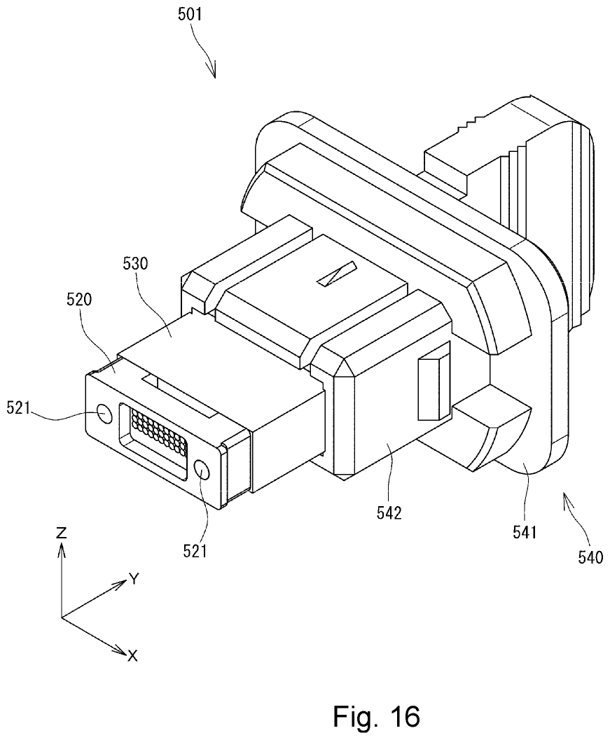

FIG. 16 is a perspective view showing an optical loopback connector 501 according to one or more embodiments of the present invention. As shown in FIG. 16, the optical loopback connector 501 of one or more embodiments has an optical loopback member 520 disposed so as to face a plurality of optical fibers of a counterpart optical connector when the optical loopback connector 501 is attached to the counterpart optical connector, a protection member 530 attached to a rear end of the optical loopback member 520, and a connector cap 540 for holding the protection member 530. The connector cap 540 has a base portion 541 and an enclosure portion 542 in the form of a box that extends from the base portion 541 and surrounds the protection member 530.

As shown in FIG. 16, through holes 521 through which the aforementioned guide pins 341 are inserted are formed in the optical loopback member 520 near opposite ends of the optical loopback member 520 in the X-direction. Through holes (not shown) that communicate with those through holes 521 are formed in the protection member 530 near opposite ends of the protection member 530 in the X-direction. Therefore, when the optical loopback connector 501 is used as a male type connector, the guide pins 341 are inserted through those through holes so that the guide pins 341 extend frontward from the optical loopback member 520.

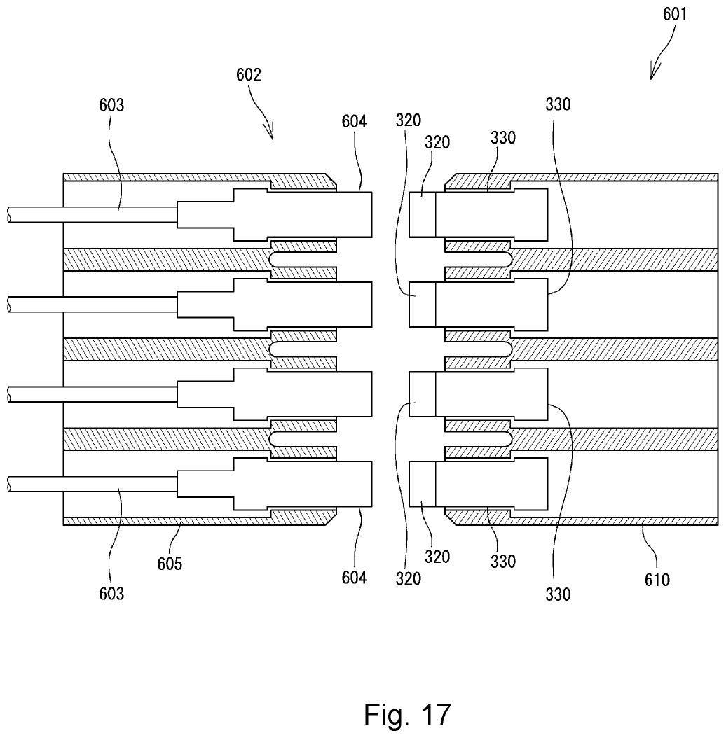

FIG. 17 is a schematic view showing an optical loopback connector 601 according to one or more embodiments of the present invention, along with a counterpart optical connector 602. This counterpart optical connector 602 has four multi-fiber optical connectors 604 connected to optical fiber cables 603 and a housing 605 that holds those multi-fiber optical connectors 604. The optical loopback connector 601 includes four sets of the optical loopback member 320 and the protection member 330 as described above so as to correspond to the counterpart optical connectors 602. Furthermore, the optical loopback connector 601 includes a housing 610 that holds the four sets of the optical loopback member 320 and the protection member 330. Thus, a plurality of optical loopback members 320 and a plurality of protection members 330 may be combined with each other in use.

In the aforementioned embodiments, the lenses 325 and 352 are formed on the optical loopback member 320. For example, those lenses 325 and 352 may not be formed on the optical loopback member 320 if any member having the same function as those lenses 325 and 352 is provided on the counterpart optical connector.

Furthermore, in the aforementioned embodiments, the first reflection portion 327A is disposed on a front side of the second reflection portion 327B. Nevertheless, the position of the first reflection portion and the second reflection portion is not limited to that example. For example, the second reflection portion may be disposed on a front side of the first reflection portion. Furthermore, the shape of the first reflection portion and the second reflection portion may be modified in a proper manner if the first reflection portion and the second reflection portion can perform the aforementioned first loopback and second loopback independently of each other. When the assembly is formed as illustrated in the aforementioned embodiments, each of the first reflection portion and the second reflection portion can be formed so as to have plane symmetry. Therefore, the first reflection portion and the second reflection portion can be formed with ease.

Moreover, in the aforementioned embodiments, light is looped back from the optical fiber 303A to the optical fiber 303B during the first loopback. As a matter of course, light may be looped back from the optical fiber 303B to the optical fiber 303A. Similarly, in the aforementioned embodiments, light is looped back from the optical fiber 304A to the optical fiber 304L during the second loopback. As a matter of course, light may be looped back from the optical fiber 304L to the optical fiber 304A.

Furthermore, in the aforementioned embodiments, each of the optical fibers 304A-304L of the counterpart optical connector 302 is located between the optical fiber 303A and the optical fiber 303B in the Z-direction (see FIGS. 12 and 14). Each of the optical fibers 304A-304L arranged in a single line along the X-direction may be arranged on an upper side of the optical fiber 303A (in the +Z-direction) or on a lower side of the optical fiber 303B (in the −Z-direction).

Although only a limited number of embodiments of the present invention have been described, the present invention is not limited to the aforementioned embodiments. It should be understood that various different forms may be applied to the present invention within the technical idea thereof. Accordingly, the scope of the invention should be limited only by the attached claims.

### INDUSTRIAL APPLICABILITY

The present invention is suitable for use in an optical loopback connector attachable to a counterpart optical connector having a plurality of optical fibers.

### DESCRIPTION OF REFERENCE NUMERALS AND SIGNS

301 Optical loopback connector

302 Counterpart optical connector

303 Optical fiber

304 Optical fiber

310 Front housing

312 Plug frame

314 Coupling

320 Optical loopback member

321 Through hole

322 Front end face

323 Rear end face

324 Recessed portion

324A Bottom surface

325 Lens

326 Recessed portion

327A First reflection portion

327B Second reflection portion

328A First reflection surface (first output light reflection surface)

328B Second reflection surface (first input light reflection surface)

329 Tip portion

330 Protection member

331 Through hole

332 Front end face

340 Pin clamp

341 Guide pin

343 Spring holder

350 Coil spring

326 Lens

360 Rear housing

361 Guide portion

362 Engagement hook

363 Spring pusher

382A First reflection surface (second output light reflection surface)

382B Second reflection surface (second input light reflection surface)

386 Recessed portion

392 Ridgeline

401 Female-type MPO connector

501 Optical loopback connector

520 Optical loopback member

521 Through hole

530 Protection member

540 Connector cap

541 Base portion

542 Enclosure portion

601 Optical loopback connector

602 Counterpart optical connector

603 Optical fiber cable

604 Multi-fiber connector

605 Housing

610 Housing

1. An optical loopback member that attaches to a counterpart optical connector to face a plurality of optical fibers of the counterpart optical connector, wherein the plurality of optical fibers comprises a first input optical fiber, second input optical fiber, first output optical fiber, and second output optical fiber, the optical loopback member comprising:
a first reflector comprising:
a first output light reflection surface that reflects a first output light, outputted in a first direction, from the first output optical fiber; and
a first input light reflection surface that:
reflects light reflected by the first output light reflection surface; and
directs the reflected light to the first input optical fiber arranged in a second direction with respect to the first output optical fiber, wherein
the second direction is perpendicular to the first direction; and
a second reflector comprising:
a second output light reflection surface that reflects a second output light from the second output optical fiber; and
a second input light reflection surface that:
reflects light reflected by the second output light reflection surface, and
directs the reflected light to the second input optical fiber arranged in a third direction with respect to the second output optical fiber, wherein
the third direction is perpendicular to the first and second directions.

2. The optical loopback member as recited in claim 1, further comprising:
a first lens that collimates the first output light and directs the collimated light to the first output light reflection surface;
a second lens that focuses the reflected light directed to the first input optical fiber from the first input light reflection surface and optically couples the focused light to the first input optical fiber;
a third lens that collimates the second output light and directs the collimated light to the second output light reflection surface; and
a fourth lens that focuses the reflected light directed to the second input optical fiber from the second input light reflection surface and optically couples the focused light to the second input optical fiber.

3. The optical loopback member as recited in claim 1, wherein the plurality of optical fibers further comprises optical fiber sets arranged in the third direction, and
each of the optical fiber sets comprises three optical fibers arranged in an array in the second direction.

4. The optical loopback member as recited in claim 1, wherein
the first reflector is disposed such that:
the first output light reflection surface reflects the first output light toward the second direction, and
the first input light reflection surface reflects light reflected by the first output light reflection surface toward the first direction.

5. The optical loopback member as recited in claim 4, wherein
the first reflector has a plane symmetrical shape that is symmetrical with respect to a plane that includes:
a line extending in the third direction; and
a line extending from a center of the first reflector in the second direction toward the first direction.

6. The optical loopback member as recited in claim 1, wherein
each of the first output light reflection surface and the first input light reflection surface is formed on a single plane that extends in parallel with the third direction.

7. The optical loopback member as recited in claim 1, wherein
the second reflector is disposed such that:
the second output light reflection surface reflects the second output light toward the third direction, and
the second input light reflection surface reflects light reflected by the second output light reflection surface toward the first direction.

8. The optical loopback member as recited in claim 7, wherein
the second reflector has a plane symmetrical shape that is symmetrical with respect to a plane that includes:
a line extending in the second direction; and
a line extending from a center of the second reflector in the third direction toward the first direction.

9. The optical loopback member as recited in claim 1,
each of the second output light reflection surface and the second input light reflection surface is formed on a single plane.

10. An optical loopback connector comprising:
an optical loopback member that attaches to a counterpart optical connector to face a plurality of optical fibers of the counterpart optical connector; and
a protector that is attachable to and detachable from the optical loopback member, wherein
the plurality of optical fibers comprises a first input optical fiber, second input optical fiber, first output optical fiber, and second output optical fiber, and
the optical loopback member comprises:
a first reflector comprising:
a first output light reflection surface that reflects a first output light outputted in a first direction from the first output optical fiber; and
a first input light reflection surface that:
reflects light reflected by the first output light reflection surface, and
directs the reflected light to the first input optical fiber arranged in a second direction with respect to the first output optical fiber, wherein
the second direction is perpendicular to the first direction; and
a second reflector comprising:
a second output light reflection surface that reflects a second output light from the second output optical fiber; and
a second input light reflection surface that:
reflects light reflected by the second output light reflection surface; and
directs the reflected light to the second input optical fiber arranged in a third direction with respect to the second output optical fiber, wherein
the third direction is perpendicular to the first and second directions.

11. The optical loopback connector as recited in claim 10, wherein
the optical loopback member further comprises:
a first lens that collimates the first output light and directs the collimated light to the first output light reflection surface;
a second lens that focuses the reflected light directed to the first input optical fiber from the first input light reflection surface and optically couples the focused light to the first input optical fiber;
a third lens that collimates the second output light and directs the collimated light to the second output light reflection surface; and
a fourth lens that focuses the reflected light directed to the second input optical fiber from the second input light reflection surface and optically couples the focused light to the second input optical fiber.

12. The optical loopback connector as recited in claim 10, wherein
the plurality of optical fibers further comprises optical fiber sets arranged in the third direction, and
each of the optical fiber sets comprises three optical fibers arranged in an array in the second direction.

13. The optical loopback connector as recited in claim 10, wherein
the first reflector is disposed such that:
the first output light reflection surface reflects the first output light toward the second direction, and
the first input light reflection surface reflects light reflected by the first output light reflection surface toward the first direction.

14. The optical loopback connector as recited in claim 13, wherein
the first reflector has a plane symmetrical shape that is symmetrical with respect to a plane that includes:
a line extending in the third direction; and
a line extending from a center of the first reflector in the second direction toward the first direction.

15. The optical loopback connector as recited in claim 10, wherein
each of the first output light reflection surface and the first input light reflection surface is formed on a single plane that extends in parallel with the third direction.

16. The optical loopback connector as recited in claim 10, wherein
the second reflector is disposed such that:
the second output light reflection surface reflects the second output light toward the third direction, and
the second input light reflection surface reflects light reflected by the second output light reflection surface toward the first direction.

17. The optical loopback connector as recited in claim 16, wherein
the second reflector has a plane symmetrical shape that is symmetrical with respect to a plane that includes:
a line extending in the second direction; and
a line extending from a center of the second reflector in the third direction toward the first direction.

18. The optical loopback connector as recited in claim 10, wherein
each of the second output light reflection surface and the second input light reflection surface is formed on a single plane.
